(19) United States
(12) Patent Application Publication
(10) Pub. No.: US 2020/0131898 A1
(43) Pub. Date: Apr. 30, 2020

(54) SYSTEM AND METHOD FOR DETERMINING AXIAL MAGNETIC INTERFERENCE IN DOWNHOLE DIRECTIONAL SENSORS

(71) Applicant: Bench Tree Group, LLC, Georgetown, TX (US)

(72) Inventors: Jian-Qun Wu, Kingwood, TX (US); Lee Jacobo Jose Roitberg, Austin, TX (US)

(21) Appl. No.: 16/169,352

(22) Filed: Oct. 24, 2018

(51) Int. Cl. E21B 47/022; E21B 7/04; E21B 47/12; G01V 3/30

(52) U.S. Cl. CPC E21B 47/02216; G01V 3/30; E21B 47/122; E21B 7/04

(57) ABSTRACT

Systems and methods for the measurement of geomagnetic field and an axial magnetic interference field using a directional sensor at a survey point are described. Generally, the directional sensor is used to make axial magnetic field measurements at three or more separate locations inside the directional sensor along the sensor tool axis. A computing system receives the axial magnetic field measurements and solves a set of simultaneous equations to obtain the axial component of the geomagnetic field.

### BACKGROUND

In drilling wells, Measurement While Drilling (MWD) directional sensors may be used to determine the orientation of the wells. Directional measurements are also called surveys in the industry. Generally, the MWD directional sensor is packaged in a section of a drill string near the bit. This sensor section is part of the Bottom Hole Assembly (BHA) where various sensors and mechanical devices are located. At the bottom end of the BHA is the drill bit.

Surveys are performed periodically during the drilling process. Usually the MWD sensor section and the drill string must be at rest during a survey operation. Thus, surveys are often performed while a section of drill pipe is added or removed from the drill string. During the pipe change process, the drill string is at rest. The result from each survey is transmitted from downhole to the surface via a telemetry system. The orientation of the well and the change in drill string length at each survey are used to calculate the trajectory of the well section at or near that survey point.

A MWD directional sensor may consist of accelerometers and magnetometers. The magnetometers in a directional sensor may be used to measure the components of the Earth's magnetic field (i.e., geomagnetic field) vector \vec{B}. The three components along the orthogonal (x, y, z) axes of the directional sensor frame are (Bx, By, Bz). The accelerometers in the directional sensor may be used to measure the gravity vector \vec{G} when the sensor is at rest. The measured gravity components are (Gx, Gy, Gz).

The orientations of the two vectors in the directional sensor frame may be used to uniquely determine the orientation of the sensor frame relative to the gravitational vertical and the magnetic north. Because a sensor is packaged rigidly on the drill string, the orientation of the drill string and the well may be known once the orientation of the directional sensor is known and vice versa.

The direction of the axis of the drill string pointing downward is often defined as the z-axis of a directional sensor frame. This is the axial direction. The x and y axes are cross-axial. In most directional sensors, the hardware axes of the magnetometers and accelerometers are nominally aligned with the directional sensor frame. There may be cases due to packaging limitations, for example, wherein the hardware axes of the component sensors are not aligned substantially with those of the directional sensor frame. Additionally, the hardware axes of magnetometers may not be nominally aligned with those of accelerometers. The measurements along the directional sensor axes are obtained through vector projections and coordinate transformations. A component of a vector in a direction is also a vector. Thus, the axial component of the geomagnetic field may be also referred to as the axial geomagnetic field.

Well inclination is the angle between the well and the vertical that is defined by the direction of gravity vector. As such, it may be a measure on how much a well deviates from being vertical. Accelerometer measurements may be used to calculate the inclination. Well azimuth relative to the North component of the geomagnetic field vector is defined as the angle between the magnetic north and the projection of the well axis on the horizontal plane as angle ϕ shown in FIG. 1. The horizontal plane is defined as a plane perpendicular to gravity.

The measurements from both the accelerometers and magnetometers may be used to calculate the azimuth. There are many formulas on how to compute the azimuth. The formulas are in essence equivalent to each other. One of the expressions for azimuth is:

ϕ32 ATAN2[(\vec{G}×\vec{B}_{N})_{z}, G\vec{B}_{N}_{_{Z}}] (EQ. 1)

wherein ATAN2[ ] is the inverse tangent function with two arguments, x is the vector cross-product symbol, subscript z denotes the z-axis component of a vector, G is the magnitude of \vec{G}, and \vec{B}_{N} is the horizontal component of the geomagnetic field vector given by:

$${\vec{B}}_{N} = \vec{B} - \frac{( \vec{B} \cdot \vec{G} )}{{G}^{2}} \vec{G} \qquad ( EQ . 2 )$$

wherein · is the vector dot-product symbol.

In a directional survey, the measured gravity and magnetic vectors are used in equations (1) and (2) to produce an azimuth. Δ\vec{B} is the error vector in the measurement of the geomagnetic field. ΔB is the magnitude of Δ\vec{B}. This error vector may come from two sources. The first source of error may be inaccuracies in the measurement of the magnetic field at the sensor location. The other source of error is the magnetic field at the sensor location not being purely geomagnetic. There may be field generated by magnetic sources in the drill string system near the directional sensor.

The measured magnetic field is:

\vec{B}′=\vec{B}+Δ\vec{B} (EQ. 3)

In practice \vec{B}′ is used in place of \vec{B} in EQ (2). If Δ\vec{B} is in the vertical direction, namely along or against \vec{G}, then \vec{B}′_{N} is identical to\vec{B}_{N}. As such, azimuth is unaffected by the vertical component of the error vector.

The azimuth error comes from the perceived magnetic north vector from the sensor measurement pointing away from the true magnetic North in the horizontal plane. A horizontal plane view of azimuth error is illustrated in FIG. 2. The horizontal component of the error of magnetic field measurement is shown as Δ\vec{B}′ₕ in FIG. 2. This error component causes the horizontal geomagnetic vector \vec{B}′_{N} to rotate by Δϕ from the true magnetic North vector \vec{B}_{N}. As such, \vec{B}′_{N} is determined by the measurement and is the vector sum of \vec{B}_{N} and ΔBₕ.

The azimuth error varies with the direction of the error vector. Let (ΔB_{N},ΔB_{E},ΔB_{V}) be of Δ\vec{B} along the geomagnetic North, geomagnetic East, and the gravitational Vertical axes, respectively. The azimuth error Δϕ due to Δ\vec{B} is given by:

Δϕ=ATAN2[ΔB_{E},B_{N}+ΔB_{N}] (EQ. 4)

wherein B_{N} is the magnitude of B_{N}. This expression can be simplified to:

$$Δϕ = arctan ( \frac{Δ {B}_{E}}{{B}_{N} + Δ {B}_{N}} ) for \vert Δ {B}_{N} \vert < {B}_{N} \qquad ( EQ . 5 )$$

The Vertical component ΔB_{V} does not play a role. It can be shown that the maximum azimuth error (i.e., worst azimuth error) due to an error vector with a magnitude ΔB in the measurement of the Earth's magnetic field is:

$${\vert Δϕ \vert}_{max} = arcsin ( \frac{Δ B}{{B}_{N}} ) for Δ B < {B}_{N} \qquad ( EQ . 6 )$$

The maximum is reached when:

$$Δ {B}_{E} = \pm Δ B \sqrt{1 - {( \frac{Δ {B}^{2}}{{B}_{N}} )}^{2}} , Δ {B}_{N} = \frac{Δ {B}^{2}}{{B}_{N}} , and Δ {B}_{V} = 0 \qquad ( EQ . 7 )$$

For most BHA and drill string combinations ΔB is much smaller than B_{N}. Thus:

$${\vert Δϕ \vert}_{max} ≅ arctan ( \frac{Δ B}{{B}_{N}} ) for Δ B ≪ {B}_{N} \qquad ( EQ . 8 )$$

If ΔB<<B_{N} is true, then the maximum azimuth error occurs when the error vector is at the Horizontal and East/West (HEW) direction (ΔB_{E}≅±ΔB, ΔB_{N}≅0, and ΔB_{V}=0). ΔB is indeed much smaller than B_{N} in many cases so that EQ. 8 can be used to estimate the maximum possible azimuth error. In those cases the azimuth error, however, can still be very large compared with the directional sensor specification. ΔB is considered negligible only when the resulting azimuth error is smaller than the error specification on azimuth.

Most sections of a drill string and many sections and components of a BHA are made of iron, steel, and other ferromagnetic metals. The unknown magnetizations in those metals produce a magnetic field near the directional sensor section. This field is superposed on the Earth's magnetic field. For directional sensing, this extra field is an offset noise. The directional information is in the Earth's magnetic field. A magnetic sensor system may measure the magnetic field correctly at the sensor location, but the field itself is corrupted by this extra field. The extra field generated by the magnetizations of ferromagnetic metals near a directional sensor interferes with the measurement of the Earth's field. In order to correctly determine the orientation of the directional sensor, this interference needs to be reduced to a negligible size and/or corrected.

The directional sensor section of a BHA is made of nonmagnetic materials. The sections axially above and below the sensor section may be nonmagnetic (i.e., “above” meaning away from the drill bit, and “below” meaning toward the drill bit as if the BHA is vertical with the drill bit being at the lower end). The field from the magnetizations in the drill string and BHA decreases with the distance between the directional sensor and the magnetization sources. If the nonmagnetic sections are long enough, then the magnetic interference is negligible at the sensor location and the measured magnetic field is that of the Earth.

Due to various constraints it may be impractical to have long nonmagnetic sections above and below the sensor location in certain drilling operations. The magnetic interference may be unavoidable in those cases. The total magnetic field at the sensor location is the vector sum of the interference field and that of the Earth. The interference may be determined and subtracted from the sensor measurement so that the Earth's magnetic field is measured correctly.

A method that corrects the interference due to the nonmagnetic sections being short is referred to as a short-collar correction method or a short-collar algorithm in the drilling industry. The traditional azimuth obtained from a directional sensor outputs without any magnetic interference correction is sometimes called a long-collar azimuth.

The magnetizations in the drill string and the BHA are mostly in the axial direction due to limited cross-axial dimension of the drill string and BHA. The axial magnetization above the nonmagnetic section can be approximated as a long magnetic dipole along the drill string axis. The magnetization in the cross-axial direction can also be viewed as a magnetic dipole in a cross-axial direction. Even if the pole strengths are similar in axial and cross-axial directions, the effective cross-axial dipole moment is much smaller than that of the axial dipole. The interference field is often dominated by the axial or longitudinal magnetization. The interference field from the section below the nonmagnetic section may have similar characteristics.

The directional sensor is some distances away axially from the axial dipoles. The interference magnetic field is in the axial direction. Thus, almost all the short-collar corrections are about correcting the magnetic interference in the measurement of the magnetic component in the z-axis.

The dominant term in the magnetic field generated by magnetizations near a directional sensor is in the z-axis direction. The associated error vector Δ\vec{B} in the measurement of the Earth's magnetic field is dominated by the term ΔB_{Z}\hat{z}, where \hat{z} s the unit vector of the sensor z-axis and ΔB_{Z} is the axial component ofΔ\vec{B}. If the true inclination and azimuth of a directional sensor are θ and φ, respectively, then:

\hat{z}=sin(θ)cos(φ)\hat{N}+sin(θ)sin(φÊ+cos(θ)\hat{V} (EQ. 9)

wherein \hat{N}, Ê, \hat{V} are the unit vectors of the geomagnetic North, geomagnetic East and the Vertical, respectively.

The azimuth error due to theΔB_{z}\hat{z} term is given by EQ. 5 as:

$$Δϕ ( Δ {B}_{z} ) = arctan ( \frac{Δ {B}_{z} sin ( θ ) sin ( ϕ )}{{B}_{N} + Δ {B}_{z} sin ( θ ) cos ( ϕ )} ) \qquad ( EQ . 10 )$$

When |ΔB_{z}|<<B_{N}, then:

$$Δϕ ( Δ {B}_{z} ) ≅ arctan ( \frac{Δ {B}_{z} sin ( θ ) sin ( ϕ )}{{B}_{N}} ) ≅ \frac{Δ {B}_{z} sin ( θ ) sin ( ϕ )}{{B}_{N}} \qquad ( EQ . 11 )$$

Thus, an axial magnetic interference may cause the largest azimuth error in a well section near the HEW direction where θ=90 degrees and φ=90 or 270 degrees. As such, the need for effective short-collar correction is the most acute when a well is at or near the HEW direction.

In a short-collar correction process, information from sources independent of the directional sensor may be used to determine what the z-axis component of the geomagnetic field is. In one short-collar algorithm, the magnitude of the measured geomagnetic field after correction is required to equal to a value obtained from a source other than the directional sensor, namely:

Bref=\sqrt{Bₓ²+B_{y}²+B_{z}²} (EQ. 12)

wherein B_{ref} is the reference value of the magnitude of the geomagnetic field at the well site and at the time of the directional sensor measurement, (Bₓ, B_{y}) are the measured magnetic field components in sensor (x,y) directions, B_{z} is the best estimate on the z-axis component of the geomagnetic field. This is the Total Field Matching Short-Collar (TFMSC) method. The reference value is obtained from an independent source unrelated to the directional sensor measurement. In TFMSC, the reference value is used as a constraint on what B_{z} must be. Namely a B_{z} that satisfies EQ. 12 is deemed to be the correct value of the z-axis component of the geomagnetic field. The difference between the z-axis magnetometer output and the solution is the interference term. There are two solutions to EQ. 12. Some criterion may then be used to choose one over the other as the correct solution. For example, for a single survey point, the solution that results in a smaller interference term may be chosen when no other information is available. For multiple survey points along a well section, the solutions resulting in a common interference term may be chosen if the interference term is expected to be constant over the well section.

In a method described in van Dongen et al., (U.S. Pat. No. 4,682,421, hereinafter referred to as “van Dongen”), the reference values on both the magnitude and the dip angle of the geomagnetic field are used to determine the correct value of B_{z}. The B_{z} that minimizes the functional E defined in van Dongen is deemed to be the correct B_{z} of the geomagnetic field. In van Dongen, \vec{B} is the geomagnetic vector measured by the directional sensor after the correction and \vec{B₀} is given by the reference source, respectively. These values are assumed to be in the same plane. The E is the magnitude of the difference vector \vec{B}−\vec{B₀}. The method of van Dongen can be labeled as the Minimum Vector Difference Short-Collar (MVDSC) algorithm.

In another method, B_{z} is chosen so that the B_{N} computed with the chosen B_{z} plus the measured (Gₓ, G_{y}, G_{z}, Bₓ, B_{y}) equal to the reference value of B_{N}. This method can be referred to as the Horizontal Component Matching Short-Collar (HCMSC) algorithm. It can be shown that there can be multiple solutions in either MVDSC or HVMSC. Some criterion is used to choose one solution as the correct one.

The TFMSC, MVDSC, and HCMSC are all reference-based correction methods. The axial geomagnetic field component B_{z} is chosen so that when it is used with other measured field components (Gₓ, G_{y}, G_{z}, Bₓ, B_{y}) to compute one property of the geomagnetic field the result matches the value of the reference exactly or as closely as possible. When multiple solutions of B_{z} exist, the sensor output B_{z} may be used in choosing one as the solution. The difference between the solution by the correction method and the measured B_{z} is the interference term ΔB_{z}. The interference term may not change if the section of a drill string and BHA near the directional sensor does not pass by a strong magnetic source. In that case for the next several directional surveys the interference term may be subtracted from the axial magnetic sensor output directly to yield a corrected B_{z} to be used for the calculation of directional parameters.

In a reference-based correction method the reference values and the cross-axial magnetometer measurements, Bₓ and B_{y} are assumed to be accurate and error-free. In reality, neither the reference values nor the cross-axial measurements may be perfect.

If the cross-axial magnetic measurements are error-free, then from EQ. 12, there exists:

$$d {B}_{z} = \frac{{B}_{ref}}{{B}_{z}} d {B}_{ref} \qquad ( EQ . 13 )$$

wherein dB_{ref} is the error in the reference value on the magnitude of the geomagnetic field and dB_{z} is the error in B_{z} created by the short-collar correction when B_{z} is given by the solution of EQ. 12.

In a well near the HEW direction, the true geomagnetic field component B_{z} is almost zero. dB_{z} can be much larger than the interference term ΔB_{z}. Namely the azimuth error using the corrected B_{z} can be larger than that of the interference term. In a well section exactly in the HEW direction, the true axial component of the geomagnetic field is 0. As such, EQ. 13 can't be used. The error in B_{z} from TFMSC can be computed from EQ. 12 directly. If the magnitude of the geomagnetic field is 50000 nT (nano Tesler) and B_{ref} is 50010 nT, then EQ. 12 gives us B_{z}=±1000 nT. The reference value is off by 10 nT (much smaller than the accuracy of any global geomagnetic model) and TFMSC creates a 1000 nT error in B_{z}. If the interference term ΔB_{z} is less than 1000 nT, then the short-collar correction made the azimuth error larger.

As can be shown in EQ. 11, when a well is in the HEW direction an axial interference may cause the largest error. Yet at or near this well attitude, the TFMSC may be the least effective due to inaccuracies in reference values.

With perfect reference values the inaccuracies in cross-axial measurements can also cause a very large error in an axial geomagnetic component determined by short-collar corrections. When the attitude of a well is near the HEW direction the actual axial component of the geomagnetic field is nearly zero. The magnitude of the geomagnetic field in the cross-axial plane:

B_{xy}=\sqrt{Bₓ²+B_{y}²} (EQ. 14)

is almost equal to the total magnitude. Namely B_{xy}≅B_{ref}. The error in an axial component determined from the TFMSC with perfect reference values is given by:

$$d {B}_{z} = - \frac{{B}_{xy}}{{B}_{z}} d {B}_{xy} \qquad ( EQ . 15 )$$

wherein dB_{xy} is the error in B_{xy}. When B_{z} is nearly zero and B_{xy} is almost the total magnitude of the geomagnetic field, the error in B_{z} determined by TFMSC can be many times larger than that of cross-axial magnetometers. For example, a 10 nT error in B_{xy} causes a 1000 nT error in B_{z} in a 50000 nT geomagnetic field if the TFMSC is applied. The 10 nT error in the cross-axial direction is transformed and amplified into a 1000 nT error in the axial direction by the short-collar correction.

In general the error in B_{z} using TFMSC is given by:

$$d {B}_{z} = \frac{{B}_{ref}}{{B}_{z}} d {B}_{ref} - \frac{{B}_{xy}}{{B}_{z}} d {B}_{xy} \qquad ( EQ . 16 )$$

As the reference values are obtained from sources unrelated to the directional sensor operation, dB_{xy} and dB_{ref} are uncorrelated. Thus:

$${d {B}_{z}^{2}}^{} = {( \frac{{B}_{ref}}{{B}_{z}} )}^{2} {d {B}_{ref}^{2}}^{} + {( \frac{{B}_{xy}}{{B}_{z}} )}^{2} {d {B}_{xy}^{2}}^{} \qquad ( EQ . 17 )$$

wherein the overbar means the statistical average.

It can be shown that other reference-based short-collar correction methods have problems with inaccuracies in reference values and/or cross-axial measurements very similar to those of TFMSC. It is well known in the industry that when the need for axial interference correction is the most acute, all known reference-based short-collar corrections tend to create bigger errors in axial geomagnetic components than the interference terms to be eliminated. Short-collar corrections are often not used when the well attitude is near the HEW direction.

There are correction methods that do not use reference sources explicitly. They are a subclass of methods of multi-station analysis. As discussed earlier the interference is in the z-axis direction. It can be a constant over multiple surveys in a section of a well for one BHA and drill string combination. As such, the interference can be regarded as a z-axis magnetometer bias error in the measurement of the geomagnetic field.

If the section of the well is very curvy, then it is possible to determine the interference term by requiring the interference-subtracted measurements to produce a constant magnitude or magnitudes with minimum variance of the geomagnetic field over the multiple surveys. The determination of the interference term is an optimization process. This correction method can be labeled as the Constant Total Field (CTF) algorithm.

In CTF, the correction procedure is a calibration process. In a calibration process, direct sensor outputs are processed to produce measurements to be compared with some reference values. Sensor calibration parameters that are used to convert raw sensor outputs into sensor measurements are adjusted so that the sensor measurements match the reference values. In CTF, the z-axis magnetic bias caused by axial magnetic interference is the calibration parameter to be determined. The constant magnitude of the geomagnetic field is the reference value to be matched.

Even though a reference value on the geomagnetic field is not required explicitly, the constant magnitude is imposed in CTF. The “constant magnitude” is in fact a piece of information on the property of the geomagnetic field that comes from sources unrelated to the directional sensor operation. Thus, CTF is also a reference-based short-collar correction. It suffers from the problems caused by the inaccuracies in the reference values and/or cross-axial magnetometer measurements as discussed earlier. For example the “constant magnitude” constraint can be erroneous. The geomagnetic field at a particular location can change by a few tens or a few hundred nT over a very short time span during the period when multiple surveys used in a CTF are conducted.

When the implicit reference values and cross-axial magnetic measurement are accurate, a method such as CTF can be effective if the multiple surveys are taken over a curvy section of a well. Some of the surveys in the set are taken at well attitudes away from the HEW direction. At those attitudes the magnitude of the magnetic field is sensitive to the interference-induced axially bias. The interference term can be accurately determined by the constant magnitude requirement by the survey data at those attitudes. The correct interference term is removed for all the survey data including those of HEW if present. Requiring survey data over a curvy section of a well, however, places a limit on where CTF can be applied.

Many horizontal wells are being drilled today. A horizontal well usually starts from being vertical near the surface. Once reaching a desired depth the well curves into being horizontal quickly. Sometimes the vertical section of a horizontal well is shared by multiple horizontal wells. In a typical horizontal well, the horizontal section of the well may be very long. Though each horizontal well goes from being vertical to horizontal, the BHA used for the later part of the horizontal section of a well may not be the same BHA used for drilling the curved section. As such, the multiple surveys used for a multiple station analysis may not be taken over a curved section of a horizontal well.

The well attitude does not vary very much over the horizontal section of a horizontal well. Even though the small variations in well attitude are important for well's production potential, the variations are small geometrically. The measured magnitudes of the geomagnetic field among a set of multiple surveys are almost a constant regardless of what z-axis bias is used to compute the magnitudes. As such, the “constant magnitude” does not help in pinpointing the z-axis bias. Thus, the axial interference can't be determined and/or removed.

Any multi-station analysis method uses some implicit reference field properties. The properties are used as constraints to a multi-station survey data set.

In addition to the problem of inaccurate reference values and cross-axial magnetometer measurements potentially causing the interference correction being more erroneous than the interference, a multi-station analysis method may also be limited by the requirement that the multiple surveys must be over a very curvy section of a well. That condition is often not met.

### SUMMARY OF EMBODIMENTS

The z-axis component of the magnetic field is measured at several locations axially apart in a sensor package for one directional survey point. The axially varying interference field and the constant z component of the Earth's magnetic field are determined directly from sensor outputs. No reference field values are used. The Earth's component is then used for magnetic azimuth calculations.

As axial magnetic interference is approximated by a magnetic field generated from a magnetic monopole located some distance away from the directional sensor. The multiple measurements on the field component along the z-axis at several known axial locations are made and are used to determine the pole strength, pole location, and the component of the Earth's field. Measurements at at least three locations are required.

### BRIEF DESCRIPTION OF THE DRAWINGS

These and other objects and features of the present invention will be more fully disclosed or rendered obvious by the following detailed description of the invention, which is to be considered together with the accompanying drawings wherein like numbers refer to like parts, and further wherein:

FIG. 1 is a graphical representation of various angles described with respect to the present disclosure, including well azimuth φ, sensor z-axis is well axis pointing down, OP represents a projection of the z-axis in the horizontal plane.

FIG. 2 is a graphical representation of a horizontal plane view of azimuth error. In this graphical representation, OP is a horizontal plane projection of z-axis, \vec{B}_{N} is a true magnetic North vector, \vec{B}′_{N} is a magnetic North vector obtained from sensor measurements with a horizontal magnetic field error Δ\vec{B}ₕ.

FIG. 3 is a schematic diagram of an exemplary directional sensor system having three axial magnetometers in accordance with the present disclosure.

FIG. 4A is side elevational diagram of another exemplary directional sensor system having a single axial magnetometer in accordance with the present disclosure.

FIG. 4B is a cross-sectional diagram of a magnetometer assembly taken along the lines 4B-4B in FIG. 4A, and constructed in accordance with the present disclosure.

FIG. 5 is a flow chart of an exemplary method for providing a survey using Single Pole Axial Interference Removal (SPAIR) in accordance with the present disclosure.

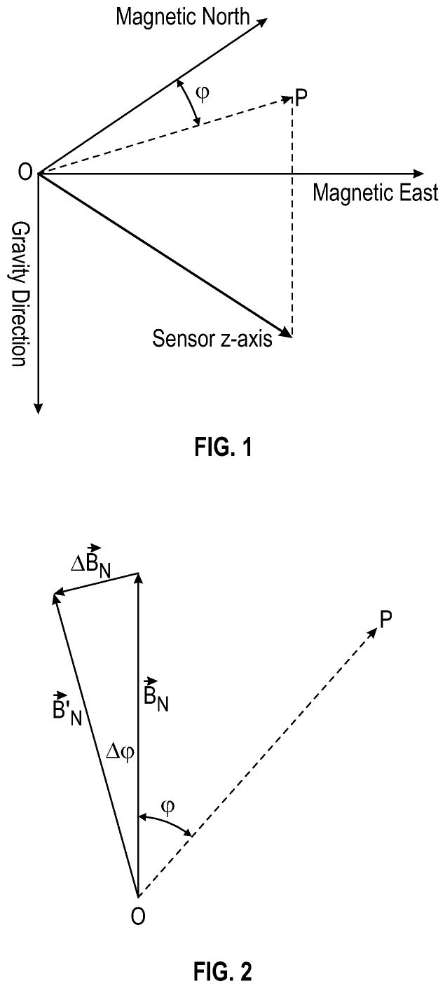

### DETAILED DESCRIPTION OF THE EMBODIMENTS

Examples of the present disclosure are directed to directional sensing systems including at least three axial magnetometers for direct measurement and/or removal of axial magnetic interference on measurement of the Earth's magnetic field. The at least three axial magnetometers may be placed at different locations about an axis of the directional sensing system. Axial interference from the nearest magnetic pole on a drill string near the directional sensing system and the Earth field may be determined simultaneously. The measured Earth field may be free of axial magnetic interference.

In some examples, the directional sensing system may be used to measure the geomagnetic field and an axial magnetic interference field. Generally, the directional sensing system may obtain axial magnetic field measurements at three or more separate locations inside the directional sensing system along an axis of the directional sensing system. A set of first equations may be solved simultaneously to obtain the axial component of the geomagnetic field. Additionally, in some embodiments, a set of second equations may be solved simultaneously to obtain a magnetic pole strength parameter and a pole position. Gravity vector and cross-axial magnetic field may be additionally measured.

In some embodiments, the directional sensing system may be used to measure the geomagnetic field at several survey points along a section of a well.

Before explaining at least one embodiment of the presently disclosed and claimed inventive concepts in detail, it is to be understood that the presently disclosed and claimed inventive concepts are not limited in their application to the details of construction, experiments, exemplary data, and/or the arrangement of the components set forth in the following description or illustrated in the drawings. The presently disclosed and claimed inventive concepts are capable of other embodiments or of being practiced or carried out in various ways. Also, it is to be understood that the phraseology and terminology employed herein is for purpose of description and should not be regarded as limiting.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, certain well-known features may not be described in detail in order to avoid unnecessarily complicating the instant disclosure.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherently present therein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

The term “and combinations thereof” as used herein refers to all permutations or combinations of the listed items preceding the term. For example, “A, B, C, and combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. A person of ordinary skill in the art will understand that typically there is no limit on the number of items or terms in any combination, unless otherwise apparent from the context.

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

The use of the terms “at least one” and “one or more” will be understood to include one as well as any quantity more than one, including but not limited to each of, 2, 3, 4, 5, 10, 15, 20, 30, 40, 50, 100, and all integers and fractions, if applicable, therebetween. The terms “at least one” and “one or more” may extend up to 100 or 1000 or more, depending on the term to which it is attached; in addition, the quantities of 100/1000 are not to be considered limiting, as higher limits may also produce satisfactory results.

Further, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

“Computing system” or “computer” used herein may include a microprocessor, or a FPGA, or an electronic device, or a desktop PC.

As used herein qualifiers such as “about,” “approximately,” and “substantially” are intended to signify that the item being qualified is not limited to the exact value specified, but includes some slight variations or deviations therefrom, caused by measuring error, manufacturing tolerances, stress exerted on various parts, wear and tear, and combinations thereof, for example.

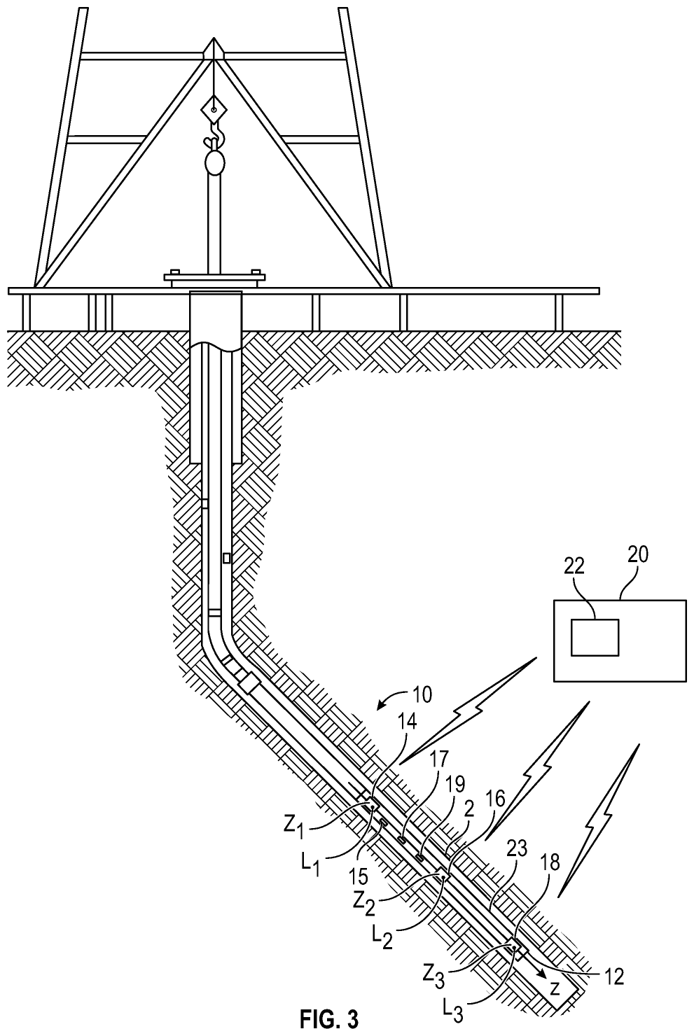

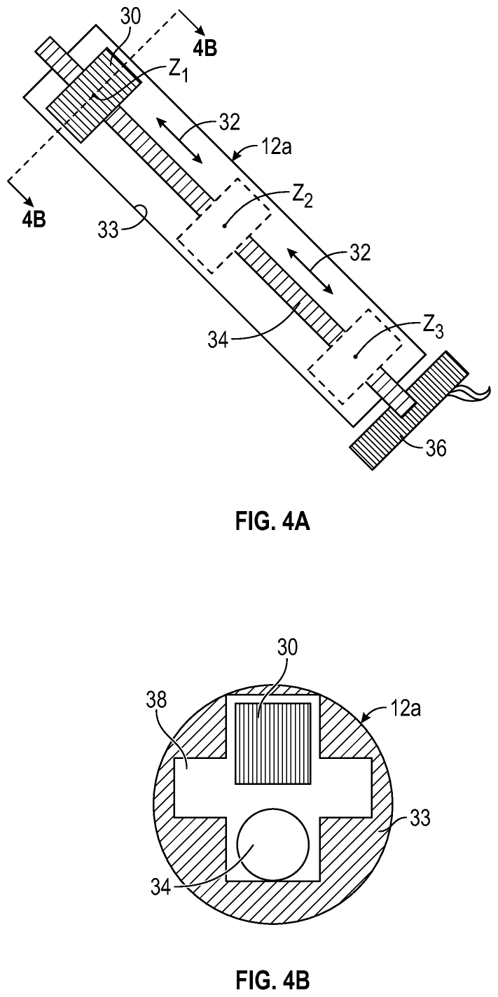

Certain exemplary embodiments of the invention will now be described with reference to the drawings. As shown in FIGS. 3, 4A and 4B, in general, such embodiments relate to a drill string system 10 and in particular to systems and methods for direct measurement and/or removal of axial magnetic interference on measurement of the Earth's magnetic field. The drill string system 10 generally includes a directional sensor system 12 having three axial magnetometers 14, 16 and 18. The directional sensor system 12 includes a z-axis.

Each axial magnetometer 14, 16 and 18 may be positioned on the z-axis of the directional sensor 12 as illustrated in FIG. 3. For example, axial magnetometer 14 is positioned at location L₁ on the z-axis of the directional sensor system 12. Axial magnetometer 16 is positioned at location L₂ on the z-axis of the directional sensor system 12. Axial magnetometer 18 is positioned at location L₃ on the z-axis of the directional sensor system 12. It should be noted that the directional sensor system 12 may include additional components, including, but not limited to accelerometers 15, cross-axial magnetometers 17, data acquisition systems 19. In addition, the directional sensor system 12 may also include busses, interconnects, and/or the like for establishing communication between the axial magnetometers 14, 16, 18, the accelerometers 15, cross-axial magnetometers 17, and the data acquisition system(s) 19. The data acquisition system(s) 19 receive sensor data from the axial magnetometers 14, 16, 18, the accelerometers 15, cross-axial magnetometers 17 and provides such sensor data to one or more computer systems 20. Furthermore, the accelerometers 15 or cross-axial magnetometers 17 may be located at or near one of the three axial magnetometers 14, 16, and 18. For simplicity in description, the axial magnetometers 14, 16 and 18 position and use within the directional sensor system 12 are described in further detail herein.

Additionally, the drill string system 10 may further include one or more computer systems 20 that are able to embody and/or execute the logic of the processes described herein. Logic embodied in the form of software instructions and/or firmware may be executed on any appropriate hardware. For example, logic embodied in the form of software instructions and/or firmware may be executed on dedicated system or systems, on distributed processing computer systems, and/or the like. In some embodiments, the logic may be implemented in a stand-alone environment operating on a single system and/or logic may be implemented in a networked environment such as a distributed system using multiple computers and/or processors. The computer system(s) 20 may work together or independently to execute processor executable code using one or more memories 22 (e.g., non-transitory memories). In some embodiments, the directional sensor system 12 may have a housing 23, and the one more computer systems(s) 20 may be within the housing 23 of the directional sensor system 12.

Axial magnetic interference may be caused by the magnetizations in sections of the drill string system 10 (e.g., magnetizations near the directional sensor system 12). In traditional directional sensors, location of a single z-axis magnetometer is fixed. The interference term can be treated as a bias error in the measurement of the geomagnetic field. The interference field is, however, not a constant. The z-axis component of the magnetic field generated by these magnetizations varies in value by the distances between the magnetizations and the sensing z-axis magnetometer. The magnetizations are mostly axial dipoles. In many cases, only one long dipole is the dominant one. This dipole may be either from a section above a directional sensor or below. The magnetic field from a long axial dipole can be computed as the total field generated by two monopoles. The two monopoles are equal in strength but opposite in sign. They are located on the axis of a well section. At location z on the well axis the axial magnetic field generated by a long dipole, ΔB_{z}(z), is:

$$Δ {B}_{z} ( z ) = \frac{q}{{( z - {z}_{n} )}^{2}} - \frac{q}{{( z - {z}_{f} )}^{2}} \qquad ( EQ . 18 )$$

wherein q is proportional to the strength of the monopoles, zₙ and z_{f} are axial positions of the near and far poles, respectively.

The magnetic field by a point dipole decreases in magnitude by a function of 1/r³ where r is the distance away from the dipole. A magnetization can be treated as a point dipole if the dimension of the magnetization is much smaller than the distance between the observation point and the magnetization. In short-collar BHA systems, however, the magnetizations cannot be treated like point dipoles. The magnetic sources can be and are often larger in axial dimension than the distance between a directional sensor and the nearest pole. Thus we have |z−zₙ|<|zₙ−z_{f}|. EQ. 18 is a formula for calculating an axial magnetic field generated by a long axial dipole.

For a long dipole, EQ. 18 shows that the magnitude of the interference field is a quadratic function of the inverse of the distances between the poles and the observation point. zₙ may be at the point where the sensor's non-magnetic section ends and the ferromagnetic section of a BHA/drill string starts. If the dominant long dipole comes from below the sensor section, then z_{f} is at or near the bottom of a BHA, a few tens of feet below zₙ. If the long dipole is above the directional sensor, then z_{f} can be hundreds of feet above zₙ. In most drilling environment ΔB_{z}(z) is negligible if |z−zₙ| is larger than 20 feet. Therefore, in cases where the interference is not negligible the second term on the right hand side of EQ. 18 is much smaller than the first term. The field from the far pole is negligible and as such:

$$Δ {B}_{z} ( z ) ≅ \frac{q}{{( z - {z}_{n} )}^{2}} \qquad ( EQ . 19 )$$

Because of limited well diameter, the directional sensor system 12 may be much longer in dimension in the axial direction than those of the cross-axial direction. Generally, for example in sonde type directional sensors, the Orientation Module (OM) may be approximately 1 to 2 inches in diameter with the sensor section being between approximately 1 to 5 feet in length. For collar based directional sensors, the sensor system may be placed on cutouts of the sub with the diameter of the sub being the diameter of the sensor section.

The axial distances between the directional sensor system 12 and the magnetizations on a drill string system 10 may also be much larger than the diameter of the drill string system 10 and/or BHA. As such, sensor measurements may be considered to be made on the axis of the drill string system 10 and/or BHA. In some embodiments, well bending and misalignment between the BHA and the well can also be ignored.

Referring to FIG. 3, axial magnetic field at three locations z₁, z₂ and z₃ inside the housing 23 of the directional sensor system 12 may be measured by at least three separate axial magnetometers 14, 16 and 18 for one survey. The housing 23 can be made of a material that does not interfere with the magnetic fields received by the axial magnetometers 14, 16, and 18. For example, the housing 23 can be made of non-ferrous material, such as copper, or a copper-alloy.

Over the axial dimension of each magnetometer 14, 16 and 18, the geomagnetic field is a constant. The axial field at each location z₁, z₂ and z₃ is the sum of the Earth's field and the interference field. The three measurements may be given by:

$$\begin{matrix}{B}_{1} = {B}_{z} + \frac{q}{{( {z}_{1} - {z}_{n} )}^{2}} & ( EQ . 20 ) \\ {B}_{2} = {B}_{z} + \frac{q}{{( {z}_{2} - {z}_{n} )}^{2}} & ( EQ . 21 ) \\ {B}_{3} = {B}_{z} + \frac{q}{{( {z}_{3} - {z}_{n} )}^{2}} & ( EQ . 22 )\end{matrix}$$

wherein B_{z} is the axial component of the geomagnetic field, (B₁, B₂, B₃) are the axial components of the total magnetic field measured at 3 known locations (z₁, z₂, z₃) on the axis of the BHA/drill string, q is proportional to the pole strength. z₁, z₂, and z₃ are in ascending order in a directional sensor system where z-axis is pointing downhole.

The proportionality of q to pole strength depends on the units used for pole strength, z-axis coordinate, and magnetic field. The product of the proportionality and the pole strength is q which can be viewed as the source for interference magnetic field. The product is an unknown to be determined as a single parameter. It is not necessary to know what the proportionality is. The q can be the pole strength in some unit system where the proportionality is 1. As such, q will be referred to as a pole strength parameter or simply pole strength hereafter.

B_{z}, q, and zₙ are unknowns in EQS. (20)-(22). The directional sensor system 12 is made of non-magnetic material. The pole that dominates the interference field must be either above or below the directional sensor system 12. As such, zₙ must be smaller than z₁ or larger than z₃ to be a valid solution. Thus, a valid solution to EQS. (20)-(22) can exist when B₁>B₂>B₃ or B₁<B₂<B₃ which can be rewritten as

$$\frac{{B}_{3} - {B}_{2}}{{B}_{2} - {B}_{1}} > 0.$$

From EQS.(20)-(22), the equation for zₙ is:

$$\begin{matrix}Δ BRS [ \frac{2 {z}_{n} - ( {z}_{1} + {z}_{2} )}{{( {z}_{n} - {z}_{1} )}^{2}} ] = \frac{2 {z}_{n} - ( {z}_{2} + {z}_{3} )}{{( {z}_{n} - {z}_{3} )}^{2}} & ( EQ . 23 ) \\ wherein \text{:} & \\ Δ BRS = ( \frac{{B}_{3} - {B}_{2}}{{B}_{2} - {B}_{1}} ) ( \frac{{z}_{2} - {z}_{1}}{{z}_{3} - {z}_{2}} ) & ( EQ . 24 )\end{matrix}$$

Because z₃>z₂>z₁ the inequality

$$\frac{{B}_{3} - {B}_{2}}{{B}_{2} - {B}_{1}} > 0 ,$$

is equivalent to ΔBRS>0. It can be shown that there is a solution to EQ. 23 if ΔBRS>0 and ΔBRS≠1. Furthermore the solution zₙ is larger than z₃ if ΔBRS>1 and is smaller than z₁ if ΔBRS<1.

EQ. 23 is cubic in zₙ. It can be proven that all 3 unrestricted solutions of EQ. 23 are real. One and only one of the three unrestricted solutions is outside the domain [z₁, z₃]. As such a valid solution of EQ.23 exists and the solution is unique. Once the unique solution of zₙ is found EQS. 20-22 become linear equations for B_{z} and q. Any two of the three equations, EQS. 20-22, can be used to solve for B_{z} and q. The second terms on the right hand side of EQS. 20-22 are the interferences on the three measurements at z₁, z₂, and z₃.

The magnetizations in a section of the drill string system 10 near the directional sensor system 12 can stay the same if the section does not pass through or pass by a strong magnetic source. Once the interference terms are determined at one survey point, the interference terms can be subtracted from the axial measurement for multiple subsequent survey points without solving EQ. 23 again. As such, only one of the 3 axial magnetic field measurements at 3 known locations (z₁, z₂, z₃) is required for those subsequent surveys. For example, at one survey point all three axial magnetic field measurements are made and EQ. 23 as well as EQS. 20-22 are solved. In addition to the correct axial geomagnetic field the interference term for the first axial magnetometer at

$${z}_{1} , \frac{q}{{( {z}_{1} - {z}_{n} )}^{2}} ,$$

becomes known. The term can be stored. For the next several survey points this term could be subtracted from B₁ at each survey point to obtain the correct axial component of the geomagnetic field B_{z} at each survey point. If the system for solving EQS. 20-22 is on a surface computer as opposed to being downhole, then for the first survey point 3 axial field measurements are transmitted from downhole to the surface. For subsequent survey points it is not necessary to transmit the other two axial magnetic field measurements from downhole to the surface. Because the downhole-to-surface data rate is very limited not having to transmit two measurements for each survey point represents a material improvements in the speed of operation.

Axial field measurement may be measured at every survey point. Surveys may be performed periodically during the drilling process. For example, surveys may be performed while a section of drill pipe is added or removed from the drill string. During the pipe change process, the drill string is at rest. The result from each survey may be transmitted from downhole to the surface via a telemetry system. The orientation of the well and the change in drill string length at each survey may be used to calculate the trajectory of the well section at or near that survey point, and thus, used to steer the drill string.

When ΔBRS≤0 or ΔBRS=1, the single pole approximation may be no longer accurate. One of the three axial measurements may then be used to generate a long-collar azimuth. Alternatively, a reference-based short-collar correction method may be applied.

When either |B₃−B₂| or |B₂−B₁| is smaller than the accuracy of the magnetometer 14, 16 and/or 18, interference may not exist and/or the single pole approximation may be erroneous. No interference determination may be performed.

It may be desirable to have large distance separations among z₁, z₂, and z₃ such that the differences among B₁, B₂, and B₃ may be greater than accuracy of the directional sensor system 12. The limiting factor may be the length of the directional sensor system 12. The distance separations may be selected to be the largest allowed by the length of the directional sensor system 12. To detect a magnetic pole equally well whether the pole is above or below a directional sensor the two distances, z₂−z₁ and z₃−z₂, may be similar. If the two distances are substantially different in the directional sensor system 12, then the directional sensor system 12 may be more accurate in determining a pole on the side of the shorter distance.

From EQS. 21 and 22 and use z for zₙ we have:

$${z}_{3} - {z}_{2} = ( {z}_{2} - z ) [ \frac{1}{\sqrt{1 - \frac{( {B}_{3} - {B}_{2} ) {( z - {z}_{2} )}^{2}}{q}}} - 1 ] \qquad EQ . 25$$

As such:

$$\frac{l}{d} = \frac{1}{\sqrt{1 - \frac{dB}{{B}_{int}}}} - 1 \qquad EQ . 26$$

where l (=z₃−z₂) is the axial magnetometer separation, d (=z₂−z) is the distance between the interfering magnetic pole and the middle axial magnetometer, dB(=B₂−B₃) is the difference in axial magnetic field caused by the interfering magnetic pole,

$${B}_{int} ( = \frac{q}{{d}^{2}} )$$

is the axial magnetic interference at the middle axial magnetometer.

### If

$$\vert \frac{dB}{{B}_{int}} \vert ≪ 1 ,$$

If then EQ. 26 becomes:

$$\frac{l}{d} ≅ \frac{1}{2} \frac{dB}{{B}_{int}} for \vert \frac{dB}{{B}_{int}} \vert ≪ 1 \qquad EQ . 27$$

For a positive d we have

$$\frac{l}{d} ≅ \frac{1}{2} \vert \frac{dB}{{B}_{int}} \vert .$$

|dB| must be equal to or larger than the axial magnetometer accuracy dBₘᵢₙ. As such:

$$\frac{l}{d} \geq \frac{1}{2} \frac{{dB}_{min}}{\vert {B}_{int} \vert} \qquad EQ . 28$$

The smallest |Bᵢₙₜ| that satisfies the inequality in EQ. 28 is |Bᵢₙₜ|ₘᵢₙ wherein:

$${\vert {B}_{int} \vert}_{min} = \frac{{dB}_{min}}{2} \frac{d}{l} \qquad EQ . 29$$

|Bᵢₙₜ|ₘᵢₙ is the accuracy on magnetic interference measurement by the sensing system of this example of the present disclosure. EQ. 29 shows that the separation between magnetometers 14, 16 and/or 18, known as l, should be as large as possible. However, generally, it may be desirable to keep the overall directional sensor system 12 as short as possible. As such, in some examples, the magnetometers, 14, 16 and/or 18 may be separated by approximately 12-inches, for example, resulting in a minimum length of 24 inches for the field sensor section of a directional sensor system 12.

EQ. 29 holds if

$$\vert \frac{dB}{{B}_{int}} \vert ≪ 1.$$

Without using the approximation:

$${\vert {B}_{int} \vert}_{min} = {dB}_{min} [ 1 + \frac{1}{{( 1 + l / d )}^{2} - 1} ] \qquad EQ . 30$$

EQ. 30 may be used to relate interference measurement accuracy to that of axial magnetic field.

FIGS. 4A and 4B illustrate another exemplary directional sensor system 12a having a single axial magnetometer 30 in accordance with the present disclosure. The single axial magnetometer 30 may be configured to be moveable in the axial direction of the directional sensor system 12a as indicated by arrows 32 such that axial magnetic field may be measured at three separate locations of the directional sensor system 12a at z₁, z₂, z₃. The directional sensor system 12a may have a housing 33 formed of non-magnetic material, such as stainless steel.

In some examples, the single axial magnetometer 30 may be mounted on a rod 34 (e.g., worm drive) driven by a stepper motor 36 (e.g., piezoelectric motor). In some examples, the single axial magnetometer 30 may be connected to a shuttle 38 configured to transport the single axial magnetometer 30 on the rod 34. For example, the rod 34 may be a threaded member with the shuttle 38 threaded thereon. The single axial magnetometer 30 may be connected to the shuttle 38 and thus transported as the shuttle moves along the rod 34.

The stepper motor 36 and rod 34 may be configured to move the single axial magnetometer 30 in the direction of arrows 32. For example, the stepper motor 36 may rotate the rod 34 causing the shuttle 36, and thus the single axial magnetometer 30, to move axially within the directional sensor system 12a. In some examples, the stepper motor 36 may not create or function on electromagnetic waves such that additional electromagnetic parameters are created and/or provided to the single axial magnetometer 30 due to the use of the stepper motor 36 and/or rod 34. In some examples, the single axial magnetometer 30 may be positioned in an offset relationship within the housing 32 (i.e., offset from the center of the housing 32 within the shuttle 36). However, the single axial magnetometer 30 may be positioned anywhere within the housing 32 (e.g., co-axial, offset).

The measurement accuracy on the difference dB is the sensor resolution, not accuracy, of the single axial magnetometer 30. Thus, dBₘᵢₙ for the directional sensor system 12a is the resolution of the single axial magnetometer 30. The resolution of the single axial magnetometer 30 may be smaller than its accuracy. This directional sensor system 12a may be much more accurate than that of three separate axial magnetometers 14, 16 and 18 of the directional sensor system 12 shown in FIG. 3, if locations of the axial magnetometers 14, 16, 18 and 30 of each system 12 and 12a respectively are the same. In some embodiments, the directional sensor system 12a can be made shorter than that of the directional sensor system 12 having three separate axial magnetometers 14, 16 and 18 with same interference measurement accuracy. The tradeoff is that the directional sensor system 12a may include mechanical complexity to move the axial magnetometer 30 to the three or more separate locations.

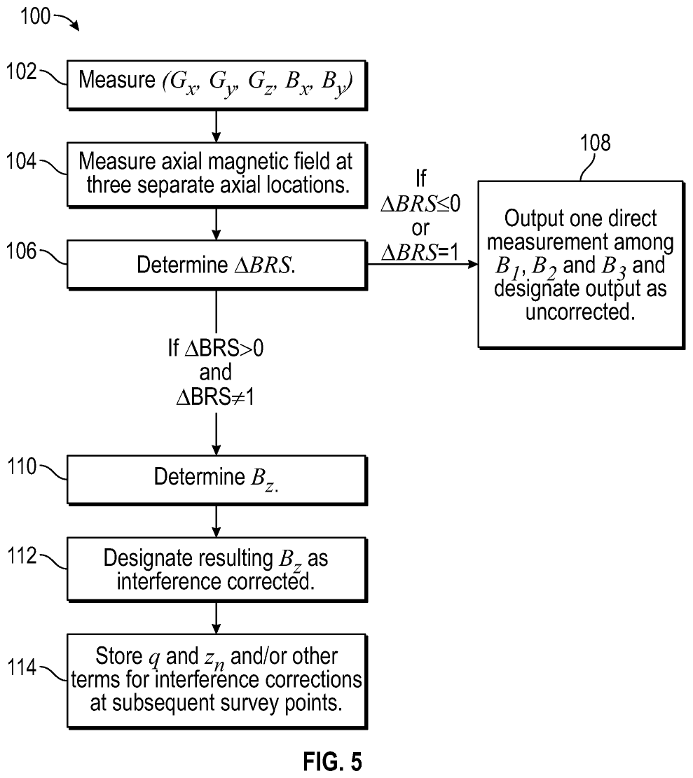

The process outlined above can be labeled as the Single Pole Axial Interference Removal (SPAIR) technique. FIG. 5 illustrates a method 100 of obtaining a single survey using the process outlined above. In a step 102, the directional sensor system 12 may measure (Gₓ, G_{y}, G_{z}, Bₓ, B_{y}). In a step 104, the directional sensor system 12 may measure axial magnetic field at three separate axial locations at z₁, z₂, and z₃ to obtain B₁, B₂, and B₃. The steps 102 and 104 may take place at the same time or in any order in time. In a step 106, the microprocessor 20 may determine ΔBRS. If ΔBRS≤0 or ΔBRS=1, then in a step 108, output one direct measurement among B₁, B₂, and B₃ used for long-collar azimuth and designate the output as uncorrected. If ΔBRS>0 and ΔBRS≠1, then in a step 110, solve EQS. 20-22 by first solving EQ. 23 and output the resulting B_{z}. In a step 112, the microprocessor 30 may designate the resulting B_{z} as interference corrected. In a step 114, the microprocessor 30 may optionally store q and zₙ or the second terms on the right hand side of the EQS. 20-22 for interference corrections at subsequent survey points.

The entire system for SPAIR may be part of a downhole system. Alternatively the field sensors may be downhole and the equation solving part of the computer system may be on the surface and the three axial magnetic field measurements as well as other sensor data are transmitted to the surface for processing and storage. In this downhole-surface system the downhole part operates very much like the existing downhole directional sensor except that three axial measurements instead of one are made and transmitted to the surface. This allows the existing hardware to be used. Three existing orientation modules may be stacked axially in a directional sensor to provide the three axial magnetic field measurements. Two of the three x-y measurements may be turned off or used as the redundant cross-axial magnetic field measurement to improve quality.

In an embodiment where axial magnetic field is measured at more than three locations along the directional sensor tool axis there are more than three equations in a simultaneous equation system relating the axial magnetic field measurements with three unknowns: axial geomagnetic field, interfering magnetic pole strength and position. Every three-equation subset of the simultaneous equation system may be used to determine axial geomagnetic field, pole strength, and pole position. The results from some or all of the subsets may be averaged to give the final result. Alternatively a numerical optimization solution may be used where a penalty function is constructed from the simultaneous equations. Hereafter the term “solve a set of simultaneous equation” may also include solving a numerical optimization problem that is based on a set of simultaneous equations.

From the above description, it is clear that the inventive concepts disclosed and claimed herein are well adapted to carry out the objects and to attain the advantages mentioned herein, as well as those inherent in the invention. While exemplary embodiments of the inventive concepts have been described for purposes of this disclosure, it will be understood that numerous changes may be made which will readily suggest themselves to those skilled in the art and which are accomplished within the spirit of the inventive concepts disclosed and claimed herein.

What is claimed is:

1. A method for the measurements of geomagnetic field and an axial magnetic interference field using a directional sensor at a survey point, the method comprising:
using the directional sensor to make axial magnetic field measurements at three or more separate locations inside said directional sensor along the sensor tool axis; and,
using a computing system to receive the axial magnetic field measurements and to solve a set of simultaneous equations to obtain the axial component of the geomagnetic field.

2. The method of claim 1 further comprising solving a set of simultaneous equations to obtain a magnetic pole strength parameter and a pole position.

3. The method of claim 2 further comprising solving a set of simultaneous equations by first solving an equation for said pole position.

4. The method of claim 1, further comprising the step of measuring, by the directional sensor, gravity vector and cross-axial magnetic field.

5. A method for measuring geomagnetic field at several survey points along a section of a well using a directional sensor, the method comprising:
using the directional sensor to make axial magnetic field measurements at three or more separate locations inside said directional sensor along the sensor tool axis at a first survey point;
using a computer system to receive the axial magnetic field measurements at said first survey point and to solve a set of simultaneous equations to obtain the axial component of the geomagnetic field and the interference terms at said three or more locations at said first survey point;
storing said interference terms in a memory;
using the directional sensor to make an axial magnetic field measurement at one location inside said sensor at a survey point subsequent to said first survey point;
subtracting an interference term associated with said one location inside said sensor from said axial magnetic field measurement at said subsequent survey point to obtain an axial component of the geomagnetic field at said subsequent survey point.

6. The method of claim 5, further comprising the step of determining a magnetic pole strength parameter and a pole position using measurements obtained at the first survey point.

7. The method of claim 6 further comprising solving a set of simultaneous equations by first solving an equation for said pole position.

8. The method of claim 5, further comprising the step of measuring gravity vector and cross-axial magnetic field at a plurality of survey points.

9. A system, comprising:
an axial magnetic sensor having at least one axial magnetometer, the axial magnetic sensor including at least one data acquisition system configured to measure axial magnetic field with the at least one axial magnetometer at at least three or more distinct locations inside the axial magnetic sensor;
a computing system used to:
receive at least three axial magnetic field measurements from distinct locations within the axial magnetic sensor; and,
determine an axial component of geomagnetic field using the axial magnetic field measurements.

10. The system of claim 9, wherein the computing system further executing instructions to determine a magnetic pole strength parameter and a pole position.

11. The system of claim 10, wherein pole position is determined prior to the magnetic pole strength parameter and the axial geomagnetic field.

12. The system of claim 9, wherein the axial magnetic sensor includes at least three axial magnetometers configured to measure axial magnetic field at at least three locations on the axis of the axial magnetic sensor.

13. The system of claim 9, wherein an axial magnetometer is configured to move to at least three different locations on the axis of the axial magnetic sensor to measure axial magnetic field at the at least three different locations.

14. The system of claim 12, further comprising wherein the computing system further determines a magnetic pole strength parameter and a pole position.

15. A system, comprising:
a directional sensor having:
at least one axial magnetometer;
a data acquisition system configured to obtain axial magnetic field measurements from the axial magnetometer at three or more locations inside the directional sensor;
a computing system used to receive axial magnetic field measurements from the directional sensor; and,
obtain an axial component of geomagnetic field using the axial magnetic field measurements.

16. The system of claim 15, the computing system further determines a magnetic pole strength parameter and a pole position.

17. The system of claim 16, wherein the determination of the pole position is prior to determination of the magnetic pole strength parameter and the axial geomagnetic field.

18. The system of claim 15, wherein the directional sensor includes at least three axial magnetometers configured to measure axial magnetic field at the at least three locations.

19. The system of claim 15, wherein an axial magnetometer is configured to move to at least three different locations to measure axial magnetic field at the at least three different locations.

20. A system, comprising:
a directional sensor having:
a plurality of accelerometers;
a plurality of magnetometers;
at least one axial magnetometer;
a data acquisition system configured to measure gravity vector, cross-axial magnetic field, and axial magnetic field with the at least one axial magnetometer at at least three locations inside the directional sensor;
a computing system having one or more non-transitory computer readable medium storing a set of computer executable instructions for running on one or more processors that when executed cause the one or more processors to:
receive the gravity vector, cross-axial magnetic field, and axial magnetic field from the directional sensor;
determine an axial component of geomagnetic field and at least one parameter of interfering magnetic field; and,
determine at least one directional parameter using the gravity vector, cross-axial magnetic field, and the axial component of geomagnetic field.

21. The system of claim 20, wherein the directional sensor includes at least three axial magnetometers at at least three locations inside the directional sensor.

22. The system of claim 21, wherein a first axial magnetometer is positioned at a distance between eight and eighteen inches from an adjacent second magnetometer.
